(19) United States
(12) Patent Application Publication
(10) Pub. No.: US 2026/0018628 A1
(43) Pub. Date: Jan. 15, 2026

(54) FLUOROELASTOMER COMPOSITIONS FOR FUEL CELL SEALS

(71) Applicant: SOLVAY SPECIALTY POLYMERS ITALY S.P.A., Bollate (Milano) (IT)

(72) Inventors: Eliana Ieva, Alessandria (IT); Matteo Fantoni, Vanzaghello (MI) (IT); Stefano Bossolo, Parabiago (MI) (IT)

(73) Assignee: SOLVAY SPECIALTY POLYMERS ITALY S.P.A., Bollate (Milano) (IT)

(21) Appl. No.: 18/992,932

(22) PCT Filed: Jul. 7, 2023
(86) PCT No.: PCT/EP2023/068820

§ 371 Date: Jan. 9, 2025

(30) Foreign Application Priority Data
Jul. 11, 2022 (EP) 22184140.6

(51) Int. Cl. H01M 8/0284; C08G 73/06; H01M 8/0286; H01M 8/10

(52) U.S. Cl. CPC H01M 8/0284; C08G 73/0622; H01M 8/0286; H01M 2008/1095

(57) ABSTRACT

The present invention relates to fuel cells that incorporate seal means, in particular seal means for sealing a bipolar plate to a membrane in a PEM fuel cell stack. The resulting fuel cell stack exhibits superior leak resistance and reduced ion leaching in water.

### TECHNICAL FIELD

This application claims priority from the patent application Nr 22184140.6, filed on 11 Jul. 2022 in EUROPE with the whole content of this application being incorporated herein by reference for all purposes.

The present invention relates to fuel cells that incorporate seal means, in particular seal means for sealing a bipolar plate to a membrane in a PEM fuel cell stack. The resulting fuel cell stack exhibits superior leak resistance and reduced ion leaching in water.

### BACKGROUND ART

Fuel cell assemblies employing proton exchange membranes are well known. Such assemblies typically comprise a stack of fuel cell modules, each module having an anode and a cathode separated by a catalytic proton exchange membrane (PEM), and the modules in the stack being connected in series electrically to provide a desired voltage output. Gaseous fuel, in the form of hydrogen or hydrogen-containing mixtures such as “reformed” hydrocarbons, flows adjacent to a first side of the membrane, and oxygen, typically in the form of air, flows adjacent to the opposite side of the membrane. Hydrogen is catalytically oxidized at the anode-membrane interface, and the resulting proton, H⁺, migrates through the membrane to the cathode-membrane interface where it combines with anionic oxygen, O⁻², to form water. Protons migrate only in those areas of the fuel cell in which the anode and cathode are directly opposed across the membrane. Electrons flow from the anode through an external circuit to the cathode, doing electrical work in a load in the circuit.

A fuel cell assembly typically comprises a plurality of fuel cell modules connected in series to form a fuel cell stack. For convenience in manufacture, and to provide a more rugged assembly, the anode for one cell and the cathode for an adjacent cell typically are formed as rigid plates and then bonded back-to-back, forming a “bipolar plate”, as is well known in the art. A fuel cell assembly thus consists typically of a stack of alternating bipolar plates and proton exchange membranes.

The bipolar plates have to perform several functions, that is to distribute the fuel and oxidant within the cell, to facilitate water management within the cell, to carry current away from the cell, and to facilitate heat management.

At the outer edges of the assembly, the plates and membranes are sealed together to contain the reactant gases and/or coolant within the assembly. Thus, an important aspect of forming a stacked fuel cell assembly is preventing leakage between the membranes and the plates.

One prior art approach has been to mold a liquid silicone rubber (LSR) gasket directly onto the bipolar plates using liquid injection molding techniques. This has proved to be difficult due to the complex shape of the seal and plate geometry, and also the very brittle nature of some composite materials typically used in forming the bipolar plates.

CN113346102 discloses the use of fluororubbers as a sealing material of proton exchange membrane fuel cell. Compared with the common rubber, the fluororubber has the following advantages due to the plurality of excellent properties: high temperature resistance, corrosion resistance, swelling resistance, aging resistance, compression set resistance, mechanical property, high vacuum resistance, flame resistance and low temperature resistance.

U.S. Pat. No. 9,105,884 further discloses the use of fluoroelastomers as fuel cells sealing means, and that such materials can also be applied in the form of an admixture with curing agents. Upon being heated to a predefined temperature or, alternatively, reaction with atmospheric moisture or exposure to ultraviolet (UV) radiation, the material may be cured in situ to form a resilient gasket, which adheres to the component surface. The gasket so formed is capable of filling gaps between mating surfaces of various components for the environmental sealing thereof.

It is a principal object of the present invention to economically and reliably seal the fuel cell components.

### SUMMARY OF THE INVENTION

The present invention provides a water based fluoroelastomer cross-linkable composition for fuel cell seals that may be applied in latex form between the components of the fuel cell, such as between the bipolar plate and the proton exchange membrane, using traditional coating applications techniques, to simplify the overall application process.

The resulting fuel cell stack exhibits superior leak resistance and reduced ion leaching in water, thus the reduction of efficiency of the fuel cell is prevented.

It is hence a first object of the present invention a method of sealing a plurality of fuel cell components, the method comprising the following steps:
step a): depositing an aqueous cross-linkable composition [composition (C)] on at least one surface of at least one of the plurality of fuel cell components;
step b): curing the composition (C) such that a seal is formed thereby; wherein the composition (C) comprises:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one basic compound [base (B)];
at least one pyridinium salt [salt (P)] complying with any of formulae (P-1) to (P-12):

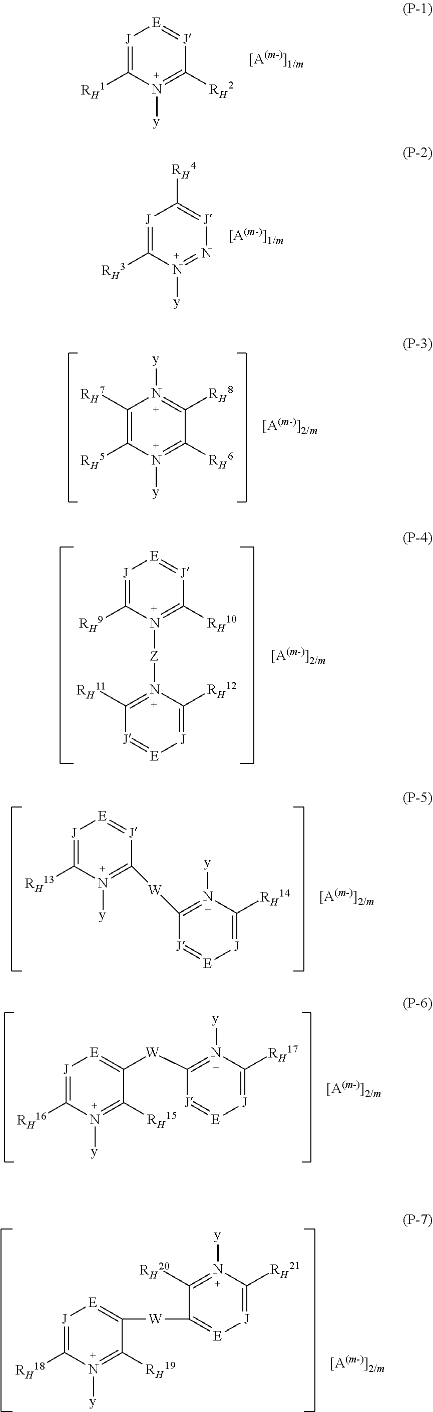

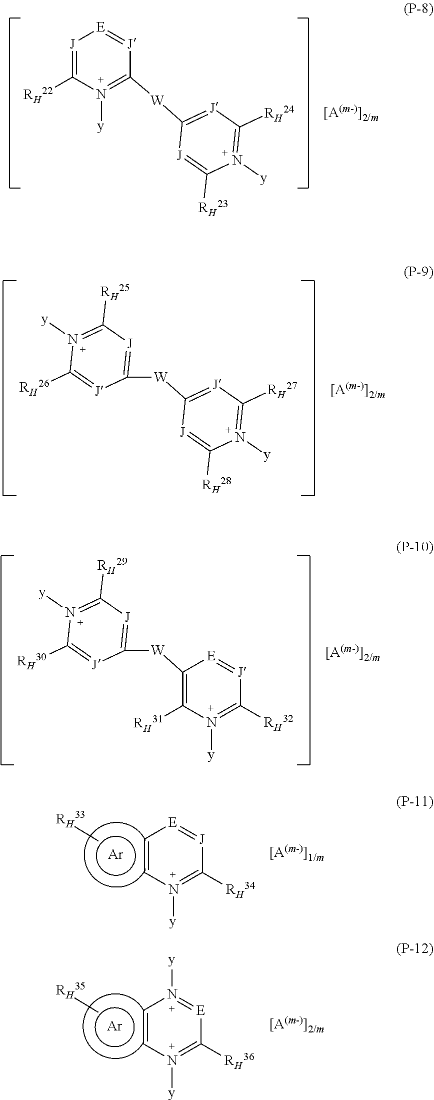

wherein:
each of J and J′, equal to or different from each other, is independently at each occurrence C—R* or N, wherein R* is H or a C₁-C₁₂ hydrocarbon group;
E is N or a group of formula C—R^{o}_{H};
Z is a divalent hydrocarbon group comprising from 1 to 12 carbon atoms;
W is a bond or is a bridging group selected from the group consisting of divalent hydrocarbon groups comprising from 1 to 12 carbon atoms (preferably divalent aliphatic groups comprising from 1 to 6 carbon atoms) and divalent fluorocarbon groups comprising from 1 to 12 carbon atoms (preferably divalent perfluoroaliphatic groups comprising from 1 to 6 carbon atoms);
the group sketched with symbol:

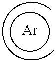

in formula (P-11) and (P-12) designates an aromatic mono- or poly-nuclear ring condensed to the pyridinium-type aromatic ring, which may comprise one or more additional nitrogen atoms, optionally quaternary nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{o}_{H}, equal to or different from each other, is independently at each occurrence-H or a group of formula [group (alpha-H)]:

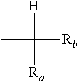

wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be an aliphatic or an aromatic group, which can comprise one or more than one heteroatoms selected from N, O, S and halogens;
A^{(m-)} is an anion having valency m;
   with the proviso that
   (i) when salt (P) is of formula (P-1) at least two of R¹_{H}, R²_{H}, and R^{o}_{H} are groups (alpha-H);
   (ii) when salt (P) is of formula (P-2) R³_{H} and R⁴_{H} are groups (alpha-H);
   (iii) when salt (P) is of formula (P-3), at least two of R⁵_{H}, R⁶_{H}, R⁷_{H}, and R⁸_{H} are groups (alpha-H);
   (iv) when salt (P) is of formula (P-4), at least two of R⁹_{H}, R¹⁰_{H}, R¹¹_{H}, R¹²_{H}, and R^{o}_{H} are groups (alpha-H);
   (v) when salt (P) is of formula (P-5), at least two of R¹³_{H}, R¹⁴_{H}, and R^{o}_{H} are groups (alpha-H);
   (vi) when salt (P) is of formula (P-6), at least two of R¹⁵_{H}, R¹⁶_{H}, R¹⁷_{H}, and R^{o}_{H} are groups (alpha-H);
   (vii) when salt (P) is of formula (P-7), at least two of R¹⁸_{H}, R¹⁹_{H}, R²⁰_{H}, R²¹_{H}, and R^{o}_{H} are groups (alpha-H);
   (viii) when salt (P) is of formula (P-8), at least two of R²²_{H}, R²³_{H}, R²⁴_{H}, and R^{o}_{H} are groups (alpha-H);
   (ix) when salt (P) is of formula (P-9), at least two of R²⁵_{H}, R²⁶_{H}, R²⁷_{H}, and R²⁸_{H} are groups (alpha-H);
   (x) when salt (P) is of formula (P-10), at least two of R²⁹_{H}, R³⁰_{H}, R³¹_{H}, R³²_{H}, and R²⁸_{H} are groups (alpha-H);
   (xi) when salt (P) is of formula (P-11), at least two of R³³_{H}, R³⁴_{H}, and R²⁸_{H} are groups (alpha-H);
   (xii) when salt (P) is of formula (P-12), at least two of R³⁵_{H}, R³⁶_{H} and R^{o}_{H} are groups (alpha-H).

In another object, the present invention provides a seal for fuel cell components, the seal being obtainable by curing a composition (C) as above defined.

In another object, the present invention provides a fuel cell assembly comprising the seal as above defined disposed between fuel cell components, and a fuel cell stack comprising a plurality of said fuel cell assemblies.

The fuel cell components are advantageously selected from bipolar plates and proton exchange membranes.

The seal of the present invention includes a thin layer of a cross-linkable fluoroelastomer disposed between the components of the fuel cell, such as between the bipolar plate and the membrane. The resulting fuel cell stack exhibits superior leak resistance and reduced ion leaching in water.

Some of the compositions (C) used in the method of the present invention are novel and represent further aspects of the present invention.

In another object, thus, the present invention provides an aqueous crosslinkable composition [composition (C1)] obtained by mixing:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one is a non-aromatic amine [base (B1)] of formula R_{bm}—NR^{H}₂
   wherein each of R^{H} is independently a C₁-C₁₂ hydrocarbon group;
R_{bm} is a monovalent hydrocarbon non-aromatic group having 1 to 30 carbon atoms; and
at least one pyridinium salt [salt (P)] complying with any of formulae (P-1) to (P-12), as above defined.

### DESCRIPTION OF EMBODIMENTS

By the term “fuel cell component”, it is hereby intended to denote each single cell component, such as bipolar plates, electrodes, membranes, or the whole proton exchange membranes.

The aqueous composition (C) of the invention is obtained by mixing a latex of polymers (A) with the salt (P) and the base (B), as above detailed.

The expression “latex” is hereby used according to its general meaning in the art, that is to say to designate stable dispersions of particles of polymer (A) in an aqueous medium. A latex is thus distinguishable notably from an aqueous slurry that can be prepared by dispersing powders a polymer in an aqueous medium and/or from a solution in a solvent able to swell or dissolve polymer (A).

The term “aqueous medium” is hereby used according to its usual meaning, i.e. intended to designate a liquid phase predominantly composed of water, being understood that minor amounts of one or more organic solvent(s), e.g. amounts of 1% wt or less, may be present without the same affecting the aqueous nature of the medium.

Polymer (A) comprises recurring units derived from vinylidene fluoride (VDF) and optionally from at least one additional comonomer different from VDF.

More specifically, according to certain embodiments, polymer (A) comprises:
recurring units derived from vinylidene fluoride (VDF) in an amount ranging from 60 to 100% moles, preferably 65 to 100% moles, more preferably 75 to 100% moles,
and optionally, recurring units derived from at least one additional comonomer [comonomer (C)] different from VDF, in an amount ranging from 0 to 40% moles, preferably 0 to 35% moles, more preferably 0 to 25% moles.

The comonomer (C) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, acrylic monomers, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (C) is preferably a fluorinated comonomer [comonomer (F)].

Non-limitative examples of suitable fluorinated comonomers (F) include, notably, the followings:
(a) C₂-C₈ perfluoroolefins such as tetrafluoroethylene (TFE), hexafluoropropylene (HFP);
(b) C₂-C₈ hydrogen-containing fluoroolefins such as vinyl fluoride, 1,2-difluoroethylene, trifluoroethylene, pentafluoropropylene and hexafluoroisobutylene;
(c) perfluoroalkylethylenes of formula CH₂═CH—R_{f0}, wherein R_{f1} is a C₁-C₆ perfluoroalkyl group;
(d) chloro- and/or bromo- and/or iodo-C₂-C₆ fluoroolefins such as chlorotrifluoroethylene (CTFE);
(e) (per) fluoroalkylvinylethers of formula CF₂═CFOR_{f1}, wherein Rø is a C₁-C₆ fluoro- or perfluoroalkyl group, e.g. —CF₃, —C₂F₅, —C₃F₇;
(f) (per) fluoro-oxyalkylvinylethers of formula CF₂═CFOX₀, wherein X₀ is a C₁-C₁₂ oxyalkyl group or a C₁-C₁₂ (per) fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per) fluorooxyalkyl group having one or more ether groups, e.g. —C₂F₅-O—CF₃;
(h) fluorodioxoles of formula:

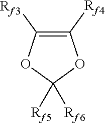

wherein each of R_{f3}, R_{f4}, R_{f5} and R_{f6}, equal to or different from each other, is independently a fluorine atom, a C₁-C₆ fluoro- or per (halo) fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride, and among these, HFP is most preferred.

According to certain embodiment's, polymer (A) comprises recurring units derived from derived from vinylidene fluoride (VDF) and from at least one hydrophilic (meth)acrylic monomer (MA), possibly in combination with one or more than one fluorinated comonomer (F).

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

According to certain embodiments, polymer (A) consists essentially of recurring units derived from VDF, and from monomer (MA).

According to other embodiments, polymer (A) consists essentially of recurring units derived from VDF, from HFP and from monomer (MA).

Polymer (A) may still comprise other moieties such as defects, end-groups and the like, which do not affect nor impair its physico-chemical properties.

The hydrophilic (meth)acrylic monomer (MA) preferably complies formula:

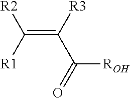

wherein each of R1, R2, R3, equal or different from each other, is independently an hydrogen atom or a C₁-C₃ hydrocarbon group, and R_{OH} is a hydroxyl group or a C₁-C₅ hydrocarbon moiety comprising at least one hydroxyl group; more preferably, each of R1, R2, R3 are hydrogen, and R_{OH} has the same meaning as above detailed, preferably R_{OH} is OH.

Non limitative examples of hydrophilic (meth)acrylic monomers (MA) are notably acrylic acid, methacrylic acid, hydroxyethyl (meth)acrylate, hydroxypropyl (meth)acrylate; hydroxyethylhexyl (meth)acrylates.

The monomer (MA) is more preferably selected among:
hydroxyethylacrylate (HEA) of formula:

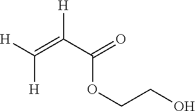

2-hydroxypropyl acrylate (HPA) of either of formulae:

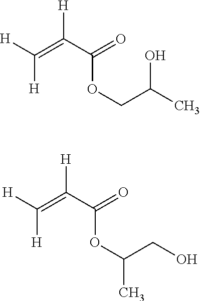

acrylic acid (AA) of formula:

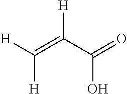

and mixtures thereof.

More preferably, the monomer (MA) is AA and/or HEA, even more preferably is AA.

Determination of the amount of (MA) monomer recurring units in polymer (A) can be performed by any suitable method. Mention can be notably made of acid-base titration methods, well suited e.g. for the determination of the acrylic acid content, of NMR methods, adequate for the quantification of (MA) monomers comprising aliphatic hydrogens in side chains (e.g. HPA, HEA), of weight balance based on total fed (MA) monomer and unreacted residual (MA) monomer during polymer (A) manufacture.

According to these embodiment's polymer (A) comprises preferably at least 0.1, more preferably at least 0.2% moles of recurring units derived from said hydrophilic (meth)acrylic monomer (MA) and/or polymer (A) comprises preferably at most 10, more preferably at most 7.5% moles, even more preferably at most 5% moles, most preferably at most 3% moles of recurring units derived from said hydrophilic (meth)acrylic monomer (MA).

According to these embodiment's, polymer (A) possesses generally a melt viscosity (MV) of at least 15 kPoise, when determined at a shear rate of 100 sec-1, and at a temperature of 230° C., according to ASTM D3835. The MV of polymer (A) is not particularly limited, but it is generally understood that MV of no more than 100 kPoise, preferably less than 80 kPoise will be adequate for ensuring optimal properties in coating applications.

According to certain embodiments, said polymer (A) comprising recurring units derived from vinylidene fluoride (VDF) and optionally from at least one additional comonomer different from VDF is a fluoroelastomer [fluoroelastomer (A)].

For the purposes of this invention, the term “fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from VDF and from at least one ethylenically unsaturated monomer comprising at least one fluorine atom (hereafter, (per) fluorinated monomer) and, optionally, recurring units derived from at least one ethylenically unsaturated monomer free from fluorine atom (hereafter, hydrogenated monomer). True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Fluoroelastomers (A) are in general amorphous products or products having a low degree of crystallinity (crystalline phase less than 20% by volume) and a glass transition temperature (Tg) below room temperature. In most cases, the fluoroelastomer (A) has advantageously a Tg below 10° C., preferably below 5° C., more preferably 0° C., even more preferably below −5° C.

Fluoroelastomer (A) typically comprises at least 15% moles, preferably at least 20% moles, more preferably at least 35% moles of recurring units derived from VDF, with respect to all recurring units of the fluoroelastomer.

Fluoroelastomer (A) typically comprises at most 85% moles, preferably at most 80% moles, more preferably at most 78% moles of recurring units derived from VDF, with respect to all recurring units of the fluoroelastomer.

Non limitative examples of suitable (per) fluorinated monomers, recurring units derived therefrom being comprised in the fluoroelastomer (A), are notably:
(a) C₂-C₈ perfluoroolefins, such as tetrafluoroethylene (TFE) and hexafluoropropylene (HFP);
(b) hydrogen-containing C₂—C: olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per) fluoroalkylvinylethers (PAVE) of formula CF₂═CFOR_{f}, wherein R_{f} is a C₁-C₆ (per) fluoroalkyl group, e.g. CF₃, C₂F₅, C₃F₇;
(e) (per) fluoro-oxy-alkylvinylethers of formula CF₂═CFOX, wherein X is a C₁-C₁₂ ((per) fluoro)-oxyalkyl comprising catenary oxygen atoms, e.g. the perfluoro-2-propoxypropyl group;
(f) (per) fluorodioxoles having formula:

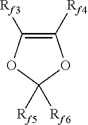

wherein R_{f3}, R_{f4}, R_{f5}, R_{f6}, equal or different from each other, are independently selected among fluorine atoms and C₁-C₆ (per) fluoroalkyl groups, optionally comprising one or more than one oxygen atom, such as notably-CF₃, —C₂F₅, —C₃F₇, —OCF₃, —OCF₂CF₂OCF₃, preferably, perfluorodioxoles;
(g) (per) fluoro-methoxy-vinylethers (MOVE, hereinafter) having formula:

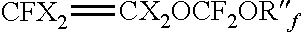

wherein R″_{f} is selected among C₁-C₆ (per) fluoroalkyls, linear or branched; C₅-C₆ cyclic (per) fluoroalkyls; and C₂-C₆ (per) fluorooxyalkyls, linear or branched, comprising from 1 to 3 catenary oxygen atoms, and X₂═F, H; preferably X₂ is F and R″_{f} is-CF₂CF₃ (MOVE1); —CF₂CF₂OCF₃ (MOVE2); or —CF₃ (MOVE3).

It is generally preferred for the fluoroealstomer (A) to comprise, in addition to recurring units derived from VDF, recurring units derived from HFP.

In this case, fluoroelastomer (A) typically comprises at least 10% moles, preferably at least 12% moles, more preferably at least 15% moles of recurring units derived from HFP, with respect to all recurring units of the fluoroelastomer.

Still, fluoroelastomer (A) typically comprises at most 45% moles, preferably at most 40% moles, more preferably at most 35% moles of recurring units derived from HFP, with respect to all recurring units of the fluoroelastomer.

Fluoroelastomers (A) suitable in the compositions of the invention may comprise, in addition to recurring units derived from VDF and HFP, one or more of the followings:
recurring units derived from at least one bis-olefin [bis-olefin (OF)] having general formula:

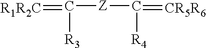

wherein R₁, R₂, R₃, R₄, R₅ and R₆, equal or different from each other, are H, a halogen, or a C₁-C₅ optionally halogenated group, possibly comprising one or more oxygen group; Z is a linear or branched C₁-C₁₈ optionally halogenated alkylene or cycloalkylene radical, optionally containing oxygen atoms, or a (per) fluoropolyoxyalkylene radical;
recurring units derived from at least one (per) fluorinated monomer different from VDF and HFP; and
recurring units derived from at least one hydrogenated monomer.

Examples of hydrogenated monomers are notably non-fluorinated alpha-olefins, including ethylene, propylene, 1-butene, diene monomers, styrene monomers, alpha-olefins being typically used. C₂-C₈ non-fluorinated alpha-olefins (OI), and more particularly ethylene and propylene, will be selected for achieving increased resistance to bases.

The bis-olefin (OF) is preferably selected from the group consisting of those complying with formulae (OF-1), (OF-2) and (OF-3):

### (OF-1)

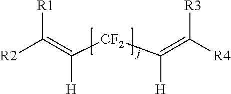

wherein j is an integer between 2 and 10, preferably between 4 and 8, and R1, R2, R3, R4, equal or different from each other, are H, F or C₁₋₅ alkyl or (per) fluoroalkyl group;

### (OF-2)

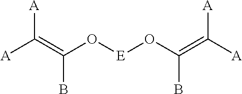

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

### (OF-3)

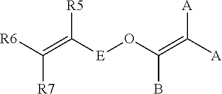

wherein E, A and B have the same meaning as above defined; R5, R6, R7, equal or different from each other, are H, F or C₁₋₅ alkyl or (per) fluoroalkyl group.

Most preferred fluoroelastomers (A) are those having following compositions (in mol % with respect to total moles of units of fluoroelastomer):
(i) vinylidene fluoride (VDF) 45-85%; hexafluoropropene (HFP) 15-45%; tetrafluoroethylene (TFE) 0-30%;
(ii) vinylidene fluoride (VDF) 20-30%; hexafluoropropene (HFP) 18-27%; C₂-C₈ non-fluorinated olefins (OI) 5-30%; perfluoroalkyl vinyl ethers (PAVE) 0-35%; bis-olefin (OF) 0-5%;
(iii) vinylidene fluoride (VDF) 60-75%; hexafluoropropene (HFP) 10-25%; tetrafluoroethylene (TFE) 0-20%; perfluoroalkyl vinyl ethers (PAVE) 1-15%.

Whichever is the nature of polymer (A), generally, particles of polymer (A) possess a primary particle average size of less than 1 μm. For the purpose of the present invention, the term “primary particles” is intended to denote primary particles of polymer (A) deriving directly from aqueous emulsion polymerization, without isolation of the polymer from the latex (i.e. the stabilized emulsion of particles). Primary particles of polymer (A) are thus to be intended distinguishable from agglomerates (i.e. collection of primary particles), which might be obtained by recovery and conditioning steps of such polymer manufacture such as concentration and/or coagulation of aqueous latexes of the polymer (A) and subsequent drying and homogenization to yield the respective powder.

Preferably, the primary particles average size of the particles of polymer (A) in dispersion (D) is above 20 nm, more preferably above 30 nm, even more preferably above 50 nm, and/or is below to 600 nm, more preferably below 400 and even more preferably below 350 nm as measured according to ISO 13321.

Preferred salts (P) of formula (P-1) are those complying with formulae (P-1-a) to (P-1-e):

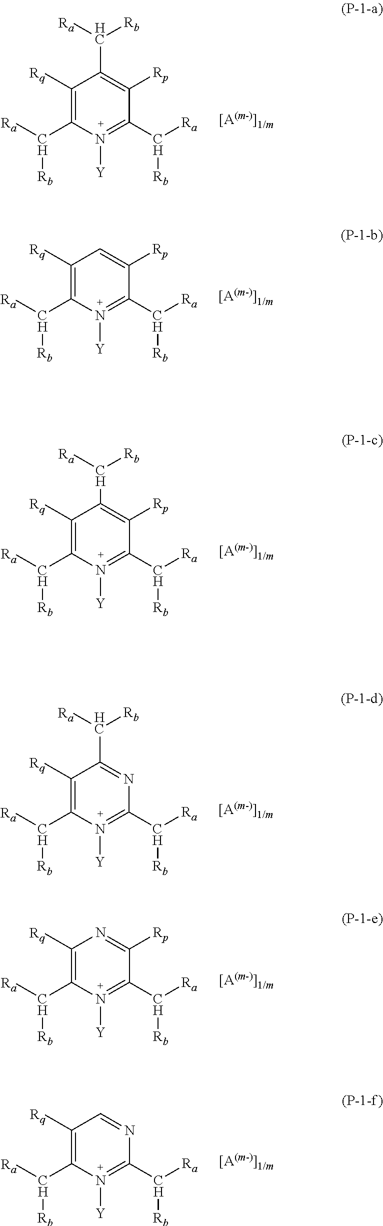

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as above defined.

More preferably, salts (P) of formula (P-1) are those having any of formulae (P-1-g) to (P-1-p):

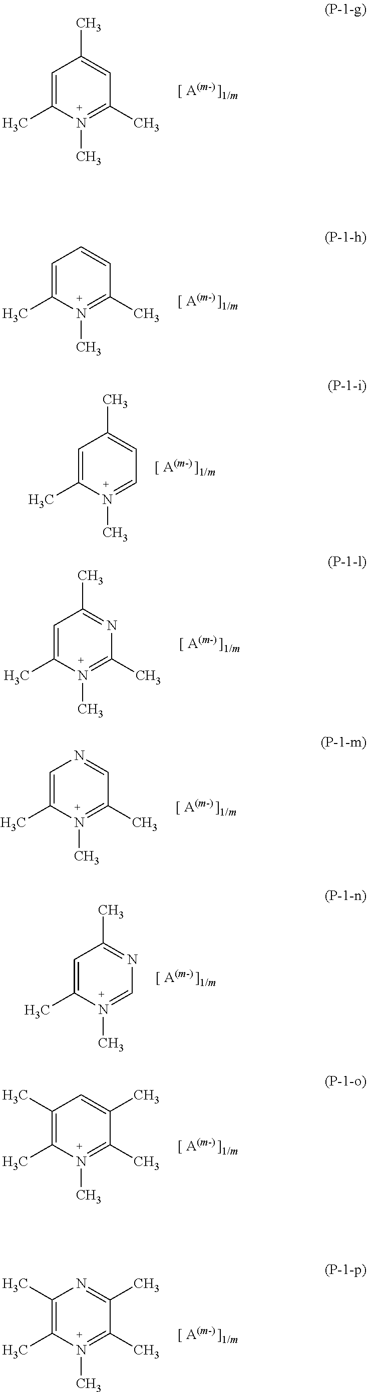

wherein A and m have the meaning as above detailed.

Preferred salts (P) of formula (P-2) are those complying with formula (P-2-a):

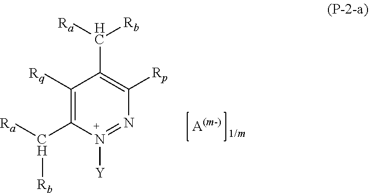

wherein:
Rₐ and R_{b} have the meaning as above defined, preferably Rₐ and R_{b} are H;
Y has the meaning as defined above, preferably Y is methyl;
each of Rₚ and R_{q}, equal to or different from each other, is H or a C₁-C₁₂ hydrocarbon group;
A and m have the meanings as above defined.

More preferably, salts (P) of formula (P-2) are those having formula (P-2-b)

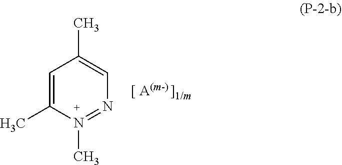

wherein A and m have the meaning as above detailed.

Preferred salts (P) of formula (P-3) are those complying with formula (P-3-a):

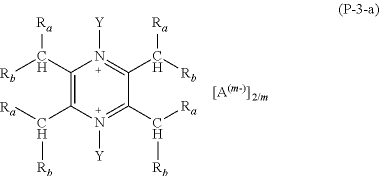

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-3) are those having formula (P-3-b)

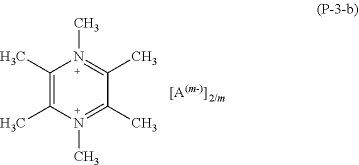

wherein A and m have the meaning as above detailed.

Preferred salts (P) of formula (P-4) are those complying with formula (P-4-a):

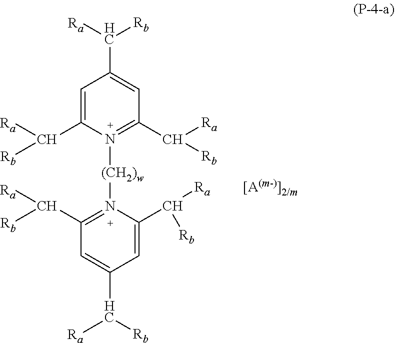

wherein:
Rₐ and R_{b} have the meaning as above defined, preferably Rₐ and R_{b} are H;
w is an integer of 1 to 12, preferably of 1 to 6, most preferably equal to 3;
A and m have the meanings as above defined.

More preferably, salts (P) of formula (P-4) are those having formula (P-4-b) or (P-4-c):

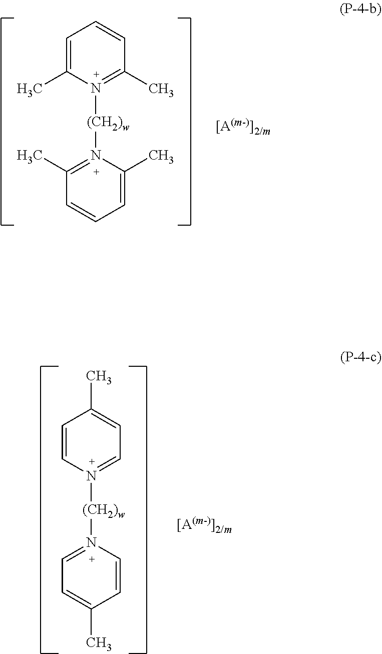

wherein A and m have the meaning as above detailed, and w=3.

Preferred salts (P) of formula (P-5) are those complying with formula (P-5-a):

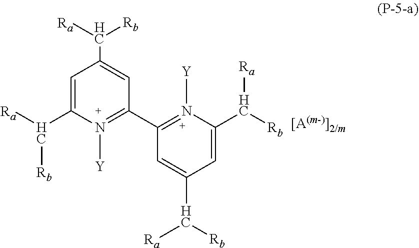

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-5) are those having formula (P-5-b) or (P-5-c):

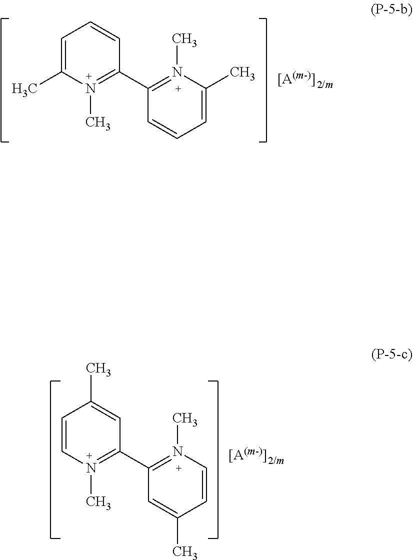

wherein A and m have the meaning as above detailed.

Preferred salts (P) of formula (P-11) are those complying with formula (P-11-a):

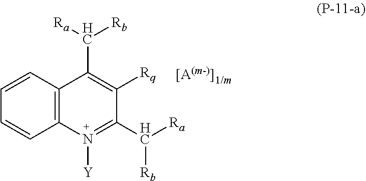

wherein:
Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-11) are those having formula (P-11-b):

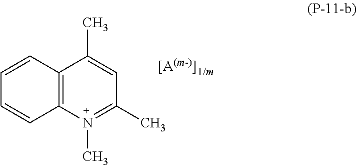

wherein A and m have the meaning as above detailed.

Preferred salts (P) of formula (P-12) are those complying with formula (P-12-a):

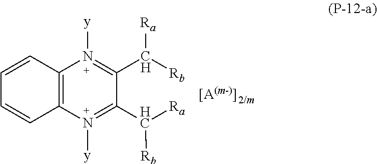

wherein:
—Rₐ and R_{b} have the meaning as above defined, preferably Rₐ and R_{b} are H;
Y has the meaning as defined above, preferably Y is methyl;
A and m have the meanings as above defined.

More preferably, salts (P) of formula (P-12) are those having formula (P-12-b):

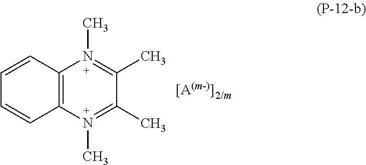

wherein A and m have the meaning as above detailed.

The choice of the anion A in formulae (P-1) to (P-12) is not particularly critical; it is nevertheless understood that anions selected from the group consisting of arylsulfonates, in particular, tosylate (p-toluensulfonate), (fluoro) alkyl sulfonates having a C₁-C₆ (fluoro) alkyl chain, including fluorine-free alkyl sulfonates e.g. mesylate (methansulfonate) and fluorine containing (especially perfluorinated) alkyl sulfonates, e.g. triflate (trifluoromethansulfonate); halides (iodide, bromide, chloride) are particularly preferred because of their prompt accessibility from synthetic perspective.

The Applicant has surprisingly found that salts (P) of any of formulae (P-1) to (P-12) including a ring-quaternized pyridinium-type nitrogen, and possessing at least two groups in ortho or para position with respect to the said ring-quaternized pyridinium-type nitrogen comprising said reactive hydrogen atoms, when combined with basic compounds in an aqueous medium, are effective cross-linking agents for the cross-linking of VDF polymers.

Without being bound by this theory, the Applicant thinks that the groups in the said ortho or para position comprising at least one hydrogen atom in alpha position with respect to the aromatic ring possess acidic character, so as to give rise, in the presence of the base (B), to corresponding carbanion; the so formed carbanions have sufficient reactivity/nucleophilic character to ensure activation and grafting of the VDF polymer chain, so as to generate a three-dimensional crosslinked network in the coated films and layers obtained therefrom.

As a whole, exemplary compounds which have been found particular utility in the composition of the present invention are those listed below having formulae (Ex-1) to (Ex-9):

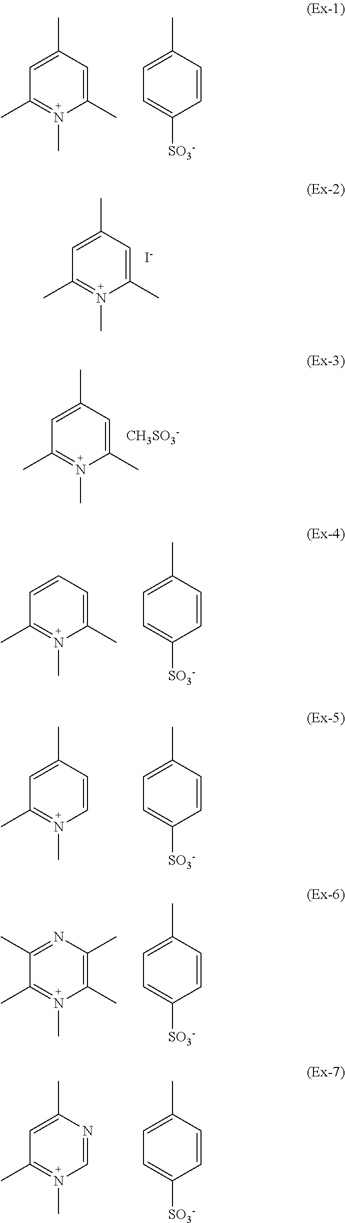

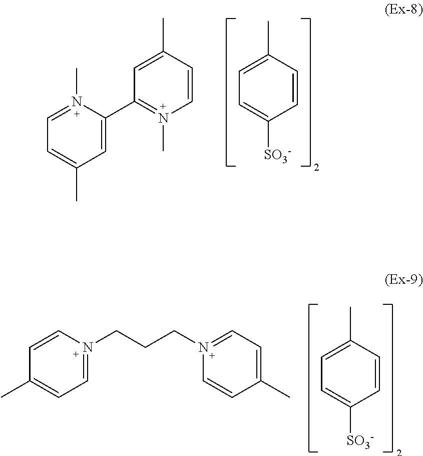

The composition of the invention generally comprises salt (P) in an amount of at least 0.1, preferably at least 0.5, more preferably at least 1 weight part per 100 weight parts of polymer (A) (phr).

The composition of the invention generally comprises salt (P) in an amount of at most 30, preferably at most 20, more preferably at most 15 weight parts per 100 weight parts of polymer (A).

The base (B) suitable for being used in the composition (C) of the present invention is not particularly limited. One or more than one organic base (B) can be used.

Among organic bases (B) mention can be notably made of:

(j) non-aromatic amines or amides complying with general formula (B1m) or (B1d):

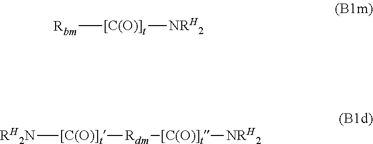

wherein:
each of t, t′ and t″, equal to or different from each other and at each occurrence is zero or 1;
each of R^{H} is independently H or a C₁-C₁₂ hydrocarbon group;
R_{bm} is a monovalent hydrocarbon non-aromatic group having 1 to 30 carbon atoms;
R_{bm} is a divalent hydrocarbon non-aromatic group having 1 to 30 carbon atoms; and
   (jj) cycloaliphatic secondary or tertiary amines complying with general formula (B2m) or (B2d):

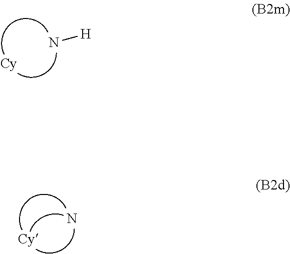

wherein:
Cy represents a divalent aliphatic group comprising at least 4 carbon atoms, optionally comprising one or more than one ethylenically unsaturated double bond, and optionally comprising one or more catenary nitrogen atoms, forming a cycle with the nitrogen atom which is connected thereto;
Cy′ represent a trivalent aliphatic group comprising at least 5 carbon atoms, optionally comprising one or more than one ethylenically unsaturated double bond, and optionally comprising one or more catenary nitrogen atoms, forming a cycle with the nitrogen atom which is connected thereto;
   (jj) aromatic amines or amides complying with general formula (B3):

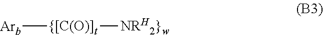

wherein:
t, equal to or different from each other and at each occurrence, is zero or 1;
w is an integer of 1 to 4;
each of R^{H} is independently H or a C₁-C₁₂ hydrocarbon group;
Ar_{b} is a mono- or poly-nuclear aromatic group, possibly comprising one or more than one catenary heteroatoms selected from the group consisting of S and O;
   (jv) heteroaromatic amines comprising at least one nitrogen atom comprised in a heteroaromatic cycle, in particular pyridine derivatives;
   (v) guanidine derivatives of formula (B4) or (B5):

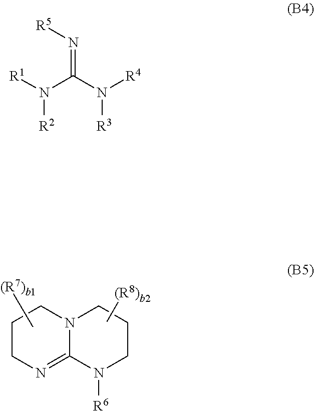

wherein:
each of R¹, R², R³, R⁴, R⁵, R⁶, R⁷, and R⁸, equal to or different from each other, is independently H or a C₁-C₁₂ hydrocarbon group and corresponding salts of said guanidines (B4) and (B5), in particular corresponding N-quaternized hydrohalides (preferably hydrochlorides);
   (vj) metal alkoxylates, preferably alkoxylates of aliphatic alcohols.

Among bases of formulae (B1m) and (B1d), those wherein:
R_{bm} is a monovalent aliphatic linear group having 6 to 30 carbon atoms, possibly comprising one or more than one ethylenically unsaturated double bond; and
R_{dm} is a divalent aliphatic linear group having 6 to 30 carbon atoms, possibly comprising one or more than one ethylenically unsaturated double bond,
   are particularly preferred.

Among the said non-aromatic amines or amides, mention can be particularly made of:
octadecylamine of formula CH₃ (CH₂)₁₇—NH₂;
erucamide of formula H₂N—C(O)—(CH₂)₁₁—CH═CH—(CH₂)₇CH₃;
oleamide of formula H₂N—C(O)—(CH₂)₇—CH═CH—(CH₂)₇CH₃;
hexamethylenediamine of formula H₂N—(CH₂)₆—NH₂;
N,N-dimethyloctylamine;
N,N-dimethyldodecylamine;
trioctylamine;
trimethylamine;
trihexylamine.

Among the said cycloaliphatic secondary or tertiary amines, mention can be made of 1,8-diazabicycloundec-7-ene (DBU) of formula:

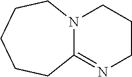 [SMILES: C1CCC2=NCCCN2CC1]

Exemplary embodiments of said guanidine derivatives of formula (B-4) are notably guanidine hydrochloride and di-o-tolylguanidine.

Exemplary embodiments of said metal alkoxylates are notably potassium terbutylate, sodium ethylate and sodium methylate.

Exemplary embodiments of said heteroaromatic amines are notably trimethylpyridine isomers.

In one preferred embodiment of the present invention, base (B) is a non-aromatic amine of formula

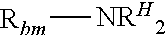

wherein each of R^{H} is independently a C₁-C₁₂ hydrocarbon group;
R_{bm} is a monovalent hydrocarbon non-aromatic group having 1 to 30 carbon atoms.

In a more preferred embodiment of the present invention, base (B) is trihexylamine.

The amount of base (B) will be adjusted by one of ordinary skills in the art, taking into account the nature and basicity of base (B) used.

It is nevertheless understood that the composition (C) generally comprises at least 0.1 weight parts of said base (B) (as above detailed), preferably at least 0.2 weight parts, more preferably at least 0.25 weight parts per 100 weight parts of polymer (A).

Further, the composition (C) generally comprises at most 30 weight parts of said base (B), preferably at most 25 weight parts, more preferably at least 20 weight parts per 100 weight parts of polymer (A).

The base (B) and the salt (P) may be added during manufacture of the composition (C) in a preliminary step, so as to generate corresponding carbanion of the salt (P).

As said, the composition (C) is an aqueous composition, that is to say it is a composition comprising a liquid medium which comprises water as major component.

While minor amounts of organic solvents may be present, it is generally understood that the liquid medium of the composition (C) essentially consists of water, and that solvents are present preferably in limited amounts, e.g. of less than 1% wt, with respect to the total weight of the composition (C), so as not to disadvantageously modify the aqueous nature of the composition, and all its advantageous environmental aspects.

The invention further pertains to a method of making composition (C), as above detailed, said method comprising mixing the aqueous latex of polymer (A), the base (B) and the salt (P), as above detailed.

Generally, the method according to the invention comprises a first step of mixing the base (B) and the salt (P) so as to obtain a pre-mix, and a second step of mixing the said pre-mix and the aqueous latex of polymer (A).

Generally, in the first step, the base (B) and the salt (P) are mixed in a liquid medium, and more specifically in an aqueous medium, i.e. a liquid medium essentially consisting of water. Minor amounts of one or more organic solvent(s) may be tolerated in the aqueous medium where mixing of base (B) and salt (P) is effected, provided their amount does not exceed 1% wt, based on the aqueous medium. Examples of organic solvent(s) which may be present as solubilization aids for the salt (P) are notably tetrahydrofurane (THF) and acetonitrile.

Base (B) and salt (P) are mixed in the first step in the said aqueous medium at a temperature of advantageously at least 10° C., preferably at least 15° C. and generally at most 60° C., more preferably at most 50° C., being understood that mixing at room temperature may be preferred, and is generally totally effective.

Without being bound by this theory, the Applicant believes that in this first step of forming the pre-mix of base (B) and salt (P), the reactive hydrogen atoms in ortho or para position with respect to the ring-quaternized pyridinium-type nitrogen of the salt (P) are removed, so as to provide for corresponding carbanion, which is the actual effective cross-linking agent for the polymer (A).

Mixing base (B) and salt (P) in the said aqueous medium can be performed in usual mixing devices, generally in vessels equipped with stirring means.

In the second step, the method includes mixing the pre-mix and the aqueous latex of polymer (A). Generally, the pre-mix is added step-wise to the aqueous latex of polymer (A); more specifically, addition of pre-mix formed in an aqueous medium may be effected drop-wise.

Mixing the aqueous latex of polymer (A) with base (B) and salt (P) or with the pre-mix thereof is generally effected in mixing devices, generally operating at low shear rate, so as to minimize shear stress-induced coagulation phenomena.

Mixing is generally carried out at temperatures of from 10 to 45° C., preferably of 15 to 35° C., being understood that mixing at room temperature may be preferred, and is generally totally effective.

In step a) of the process of the invention, the aqueous crosslinkable sealing composition (C) can be applied on at least one surface of at least one of the plurality of fuel cell components in latex form, using traditional coating application techniques, such as spray coatings, dip-coatings, cast-film, impregnation, screen printing.

After the application of composition (C) onto the at least one surface of a fuel cell component, the composition layer is preferably dried before subjecting the same to step b). Drying is preferably carried out at a temperature comprised between 30° C. and 100° C., preferably 40° C. and 50° C.

In step b) of the process, curing of composition (C) can be obtained by thermally crosslinking the same once the aqueous crosslinkable sealing composition (C) is applied at least one side of a fuel cell component, such as onto at least one surface of the proton exchange membrane or onto at least one surface of a bipolar plate, thus providing a fuel cell assembly having improved performances, in particular in terms of leak resistance, so that the overall metal ions content that may be found to leach in water during the fuel cell operation is reduced.

Thermal crosslinking can be carried out by heating the composition (C) at a temperature that may vary from about 150° C. to about 400° C., preferably at a temperature of less than 300° C., more preferably less than 200° C.

In another object, the present invention provides a seal for fuel cell components, the seal being obtainable by curing a composition (C) as above defined.

The seal of the present invention includes a thin layer of a cross-linkable fluoroelastomer disposed between the components of the fuel cell, such as between the bipolar plate and the proton exchange membrane. When the seal of the present invention is in use in a fuel cell stack, a reduced amount of ions is present thanks to the specific components of composition (C) used; further, thanks to the superior leak resistance of the seal of the present invention, ion leaching is prevented and the efficiency of the fuel cell is preserved.

Some of the compositions (C) used in the method of the present invention are novel and represent further aspects of the present invention.

In another object, thus, the present invention provides an aqueous composition [composition (C1)] obtained by mixing:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one non-aromatic amine [base (B1)] of formula

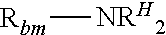

wherein each of R^{H} is independently a C₁-C₁₂ hydrocarbon group;
R_{bm} is a monovalent hydrocarbon non-aromatic group having 1 to 30 carbon atoms;
at least one pyridinium salt [salt (P)] complying with any of formulae (P-1) to (P-12), as above defined.

In a more preferred embodiment of the present invention, base (B) in composition (C1) is trihexylamine.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL SECTION

### Raw Materials

Tecnoflon® TN latex, commercially available from Solvay Specialty Polymers; solid content equal to 65-68 wt %.

### EXAMPLES

### Preparative Example 1—1,2,4,6-tetramethyl-pyridinium p-toluenesulphonate of formula

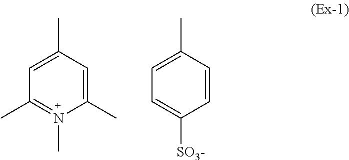

A three-necked round bottom flask equipped with thermometer, condenser and stirring was charged with CH₂Cl₂ (85 ml) and methyl-p-toluenesulphonate (25.50 g). Then 2,4,6 trimethylpyridine (16.59 g) was added drop-wise at room temperature. The reaction was stirred at 50° C. and, after 22 hours, it was completed. The liquid phase was removed by evaporation under vacuum obtaining a white powder that was dispersed in diethyl-ether (50 ml) under stirring. The liquid phase was filtered off and 39.13 g of pure product was recovered as a white powder in 93% yield (melting point 161° C.; 1% weight loss: 266° C.).

¹H NMR (solvent D₂O, TMS reference): +7.70 ppm (d; 2H; ortho-H; p-toluenesulphonate); +7.55 (s; 2H; meta-H; 1,2,4,6-tetramethyl-pyridinium); +7.39 (d; ²H; meta-H; p-toluenesulphonate); +4.0 (s; 3H; NCH₃; 1,2,4,6-tetramethyl-pyridinium); +2.74 (s; 6H; ortho-CH3; 1,2,4,6-tetramethyl-pyridinium); 2.53 (s; 3H; para-CH₃; 1,2,4,6-tetramethyl-pyridinium); +2.44 ppm (s; 3H; para-CH₃; p-toluenesulphonate).

### Preparative Example 2: Preparation of Pyridinium Salt and Trihexylamine Solution

To a solution of 1,2,4,6-tetramethyl-pyridinium p-toluenesulphonate (13.7 g; 0.05 mol) in water (90 ml), trihexylamine (24 g, 0.1 mol) in water (17.5 ml) was added. The mixture (Preparation A) was stirred for 2.5 hours at room temperature.

### Preparative Example 3: Preparation of Pyridinium Salt and Sodium Hydroxide (Comparative)

To a solution of 1,2,4,6-tetramethyl-pyridinium p-toluenesulphonate (13.7 g; 0.05 mol) in water (90 ml), a solution of sodium hydroxide (4.2 g, 0.1 mol) in water (17.5 ml) was added. The mixture (Preparation B) was stirred for 2.5 hours at room temperature.

### Example 1: Preparation of Composition CA

To 140 g of latex of TN latex, 9.2 g of the Preparation A was added dropwise.

The system was left in agitation at room temperature for 60 minutes. Afterwards, the water dispersion thus obtained was casted on a chromated aluminium Q-panel test-substrate. The coated panels were let dry at 40° C. for 1 hour; then baked at 190° C. for 60 minutes in an air oven.

### Example 2—Comparative: Preparation of Composition CB

To 140 g of latex of TN latex, 9.7 g of the Preparation B was added dropwise.

The system was left in agitation (at 18-22° C.) for 60 minutes. Afterwards, the water dispersion thus obtained was casted on a chromated aluminium Q-panel test-substrate. The coated panels were let dry at 40° C. for 1 hour; then backed at 190° C. for 60 minutes in an air oven.

### Soaking Test

The coated panels (both from CA and CB composition) were put in a jar filled with deionized water per ASTM D1193 Type I. The conductivity of the solution was measured. Then the jar was placed in an oven at 80° C. for 15 days. Afterwards, the final conductivity of the water solution was measured, to check the amount of ionic species that were leached into the water.

Then, the leached water was injected in a fuel cell and the variation of the current, before and after the leachate solution was injected, was measured: lower Delta I means smaller influence of the leachate water on the membrane efficiency and power generated.

Results are summarized in Table 1.

### Determination of Metal Ion Content

The amount of metals in Composition CA and Composition CB was determined by Inductively Coupled Plasma Emission Spectroscopy (ICP-OES).

Composition CA and Composition CB were pre-heated to remove water; then, the residues were calcinated (at 550° C., either by bunsen flame or semi-assisted muffle) and then the residues were dissolved in acid (H₂SO₄).

The acid solutions thus obtained were injected into a high-temperature energy source (ICP).

Excited atoms emit radiation with typical and defined wavelengths producing the emission spectrum. The intensity of this emission is proportional to the concentration of the free atoms within the source.

The concentrations of each element were obtained through the comparison with a calibration curve.

The results are reported in Table 1.

TABLE 1

| | | | Na (μg/g)- |
|---|---|---|---|
| | Conductivity | delta I | measured |
| Example | (μS) | (mA/cm²) | with ICP |
| 1 | 127.1 | 4 | 3 |
| 2 | 398.5 | 612 | 1390 |

As shown in Table 1, the water conductivity after the soaking test was lower when the composition comprising trihexylamine was used instead of the one with the inorganic base.

In addition, also the variation of current when the leachate water was injected in the fuel cell was much lower in the case of the composition comprising trihexylamine, thus satisfying the high purity requirement necessary for the fuel cell application.

Furthermore, the results demonstrate that the aqueous cross-linkable compositions according to the invention, thanks to the presence of certain non-aromatic amines, have a lower metal ions content compared to the compositions comprising inorganic bases; this makes the composition of the present invention particularly suitable for use in the preparation of seals for fuel cells.

In view of the above, it has been found that the compositions of the present invention are suitable for being easily applied onto fuel cell components to provide a fluoroelastomer latex composition crosslinked with pyridinium salt and certain organic bases that allows efficient sealing and to minimizes the reduction of efficiency of the fuel cell due to ion leaching.

1. A method of sealing a plurality of fuel cell components, the method comprising the following steps:
step a): depositing an aqueous cross-linkable composition [composition (C)] on at least one surface of at least one of the plurality of fuel cell components;
step b): curing the composition (C) such that a seal is formed thereby;
wherein the composition (C) comprises:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one basic compound [base (B)]; —at least one pyridinium salt [salt (P)] complying with any of formulae (P-1) to (P-12): 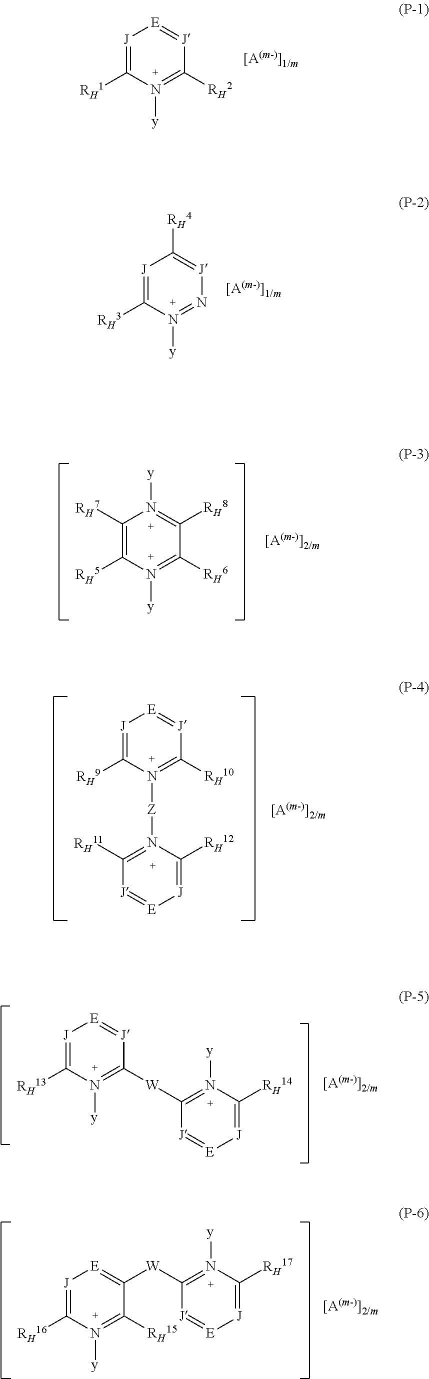 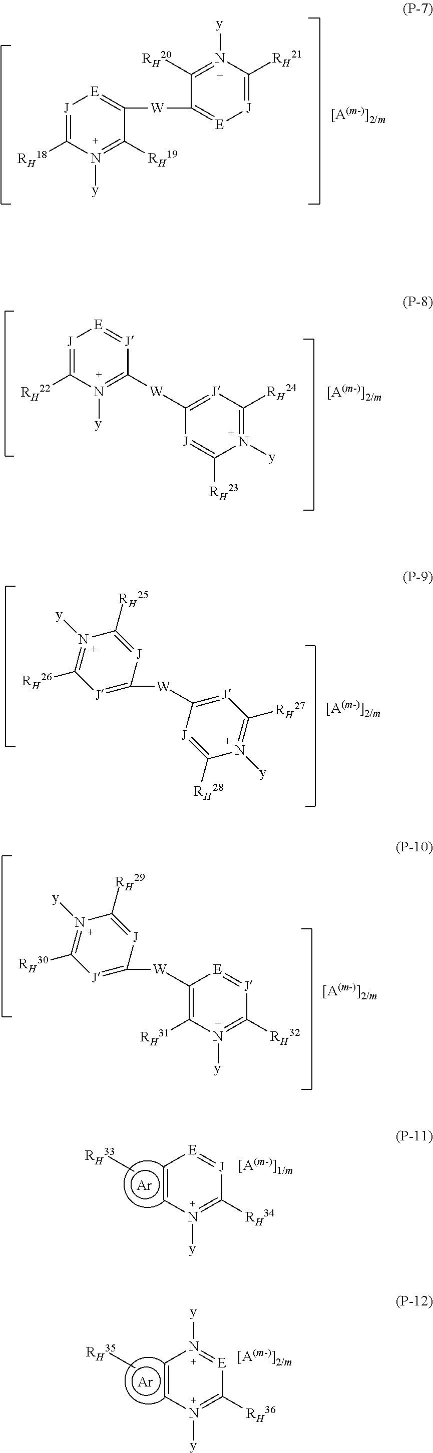
wherein:
each of J and J′, equal to or different from each other, is independently at each occurrence C—R* or N, wherein R* is H or a C₁-C₁₂ hydrocarbon group;
E is N or a group of formula C—R^{o}H;
Z is a divalent hydrocarbon group comprising from 1 to 12 carbon atoms;
W is a bond or is a bridging group selected from the group consisting of divalent hydrocarbon groups comprising from 1 to 12 carbon atoms and divalent fluorocarbon groups comprising from 1 to 12 carbon atoms;
the group sketched with symbol: 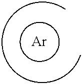
in formula (P-11) and (P-12) designates an aromatic mono- or poly-nuclear ring condensed to the pyridinium-type aromatic ring, which may comprise one or more additional nitrogen atoms, optionally quaternary nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{o}_{H}, equal to or different from each other, is independently at each occurrence-H or a group of formula [group (alpha-H)]: 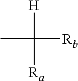
wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be notably an aliphatic or an aromatic group, which can comprise one or more than one heteroatoms selected from N, O, S and halogens;
A^{(m-)} is an anion having valency m;
with the proviso that
(i) when salt (P) is of formula (P-1) at least two of R¹_{H}, R²_{H}, and R^{o}_{H} are groups (alpha-H);
(ii) when salt (P) is of formula (P-2) R³_{H} and R⁴_{H} are groups (alpha-H);
(iii) when salt (P) is of formula (P-3), at least two of R⁵_{H}, R⁶_{H}, R⁷_{H}, and R⁸_{H} are groups (alpha-H);
(iv) when salt (P) is of formula (P-4), at least two of R⁹_{H}, R¹⁰_{H}, R¹¹_{H}, R¹²_{H}, and R^{o}_{H} are groups (alpha-H);
(v) when salt (P) is of formula (P-5), at least two of R¹³_{H}, R¹⁴_{H}, and R^{o}_{H} are groups (alpha-H);
(vi) when salt (P) is of formula (P-6), at least two of R¹⁵_{H}, R¹⁶_{H}, R¹⁷_{H}, and R^{o}_{H} are groups (alpha-H);
(vii) when salt (P) is of formula (P-7), at least two of R¹⁸_{H}, R¹⁹_{H}, R²⁰_{H}, R²_{H}, and R^{o}_{H} are groups (alpha-H);
(viii) when salt (P) is of formula (P-8), at least two of R²²_{H}, R²³_{H}, R²⁴_{H}, and R^{o}_{H} are groups (alpha-H);
(ix) when salt (P) is of formula (P-9), at least two of R²⁵_{H}, R²⁰_{H}, R²_{H}, and R²⁸_{H} are groups (alpha-H);
(x) when salt (P) is of formula (P-10), at least two of R²⁹_{H}, R³⁰_{H}, R³¹_{H}, R³²_{H}, and R²⁸_{H} are groups (alpha-H);
(xi) when salt (P) is of formula (P-11), at least two of R³³_{H}, R³⁴_{H}, and R²⁸_{H} are groups (alpha-H);
(xii) when salt (P) is of formula (P-12), at least two of R³⁵_{H}, R³⁶_{H} and R^{o}_{H} are groups (alpha-H).

2. The method according to claim 1, wherein polymer (A) comprises:
recurring units derived from vinylidene fluoride (VDF) in an amount ranging from 60 to 100% moles,
and optionally, recurring units derived from at least one additional comonomer [comonomer (C)] different from VDF, in an amount ranging from 0 to 40% moles, preferably 0 to 35% moles, more preferably 0 to 25% moles.

3. The method according to claim 1, wherein the comonomer (C) is either a hydrogenated comonomer [comonomer (H)] which is an ethylenically unsaturated comonomer free of fluorine atoms; or a fluorinated comonomer [comonomer (F)], which is an ethylenically unsaturated comonomer comprising at least one fluorine atom.

4. The method according to claim 3, wherein polymer (A) comprises recurring units derived from derived from vinylidene fluoride (VDF) and from at least one hydrophilic (meth)acrylic monomer (MA), possibly in combination with one or more than one fluorinated comonomer (F), wherein said hydrophilic (meth)acrylic monomer (MA) complies with formula: 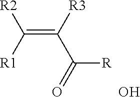
wherein each of R¹, R², R³, equal or different from each other, is independently an hydrogen atom or a C₁-C₃ hydrocarbon group, and Ron is a hydroxyl group or a C₁-C₅ hydrocarbon moiety comprising at least one hydroxyl group; more preferably, each of R1, R2, R3 are hydrogen, and ROH has the same meaning as above detailed.

5. The method according to claim 1, wherein polymer (A) is selected from fluoroelastomers (A) having following compositions (in mol % with respect to total moles of units of fluoroelastomer):
(i) vinylidene fluoride (VDF) 45-85%; hexafluoropropene (HFP) 15-45%; tetrafluoroethylene (TFE) 0-30%;
(ii) vinylidene fluoride (VDF) 20-30%; hexafluoropropene (HFP) 18-27%; C₂-C₈ non-fluorinated olefins (01) 5-30%; perfluoroalkyl vinyl ethers (PAVE) 0-35%; bis-olefin (OF) 0-5%;
(iii) vinylidene fluoride (VDF) 60-75%; hexafluoropropene (HFP) 10-25%; tetrafluoroethylene (TFE) 0-20%; perfluoroalkyl vinyl ethers (PAVE) 1-15%.

6. The method according to claim 1, wherein salts (P) of formula (P-1) are those having any of formulae (P-1-g) to (P-1-p): 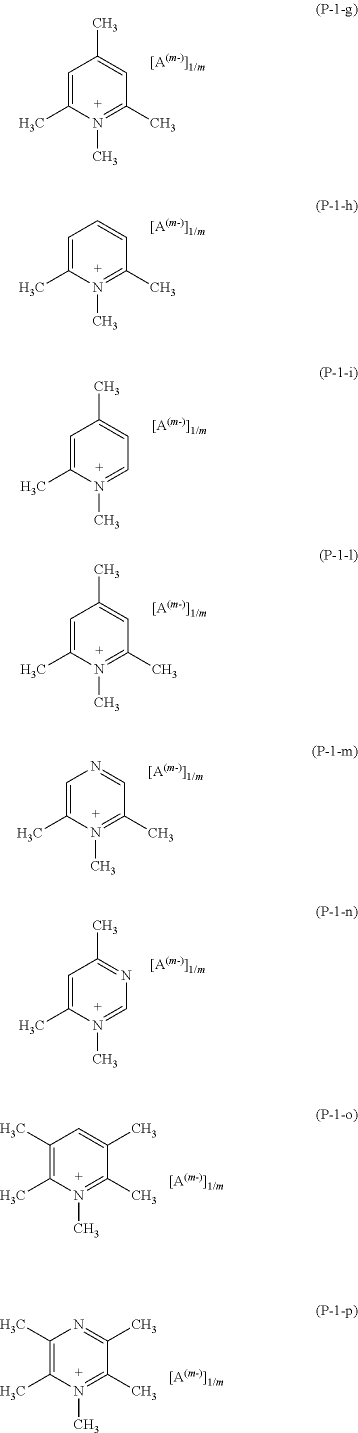
wherein A^{(m-)} is an anion having valency m.

7. The method according to claim 1, wherein the composition (C) comprises salt (P) in an amount of at least 0.1 weight part per 100 weight parts of polymer (A) (phr) and/or in an amount of at most 20 weight parts per 100 weight parts of polymer (A).

8. The method according to claim 1, wherein the base (B) is selected from non-aromatic amines of formula R_{bm}—NR^{H}₂ wherein each of R^{H} is independently a C₁-C₁₂ hydrocarbon group;
R_{bm} is a monovalent hydrocarbon non-aromatic group having 1 to 30 carbon atoms.

9. The method according to claim 1, wherein in step a) the composition (C) is applied on at least one surface of at least one of the plurality of fuel cell components in latex form, using traditional coating application techniques.

10. The method according to claim 1, wherein in step b) of the process, curing of composition (C) is obtained by thermally crosslinking the same by heating the composition (C) at a temperature in the range from about 150° C. to about 400° C.

11. The method according to claim 1, wherein the plurality of fuel cell components is composed of bipolar plates and proton exchange membranes.

12. A seal for fuel cell components, the seal being obtainable by curing a composition (C), said composition (C) comprising:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one basic compound [base (B)];
at least one pyridinium salt [salt (P)] complying with any of formulae (P-1) to (P-12): 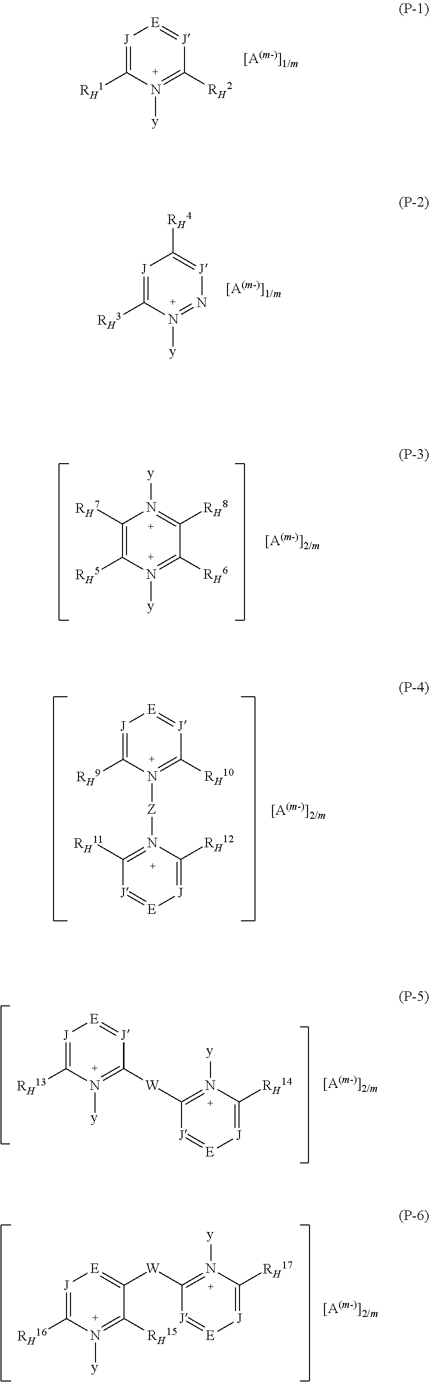 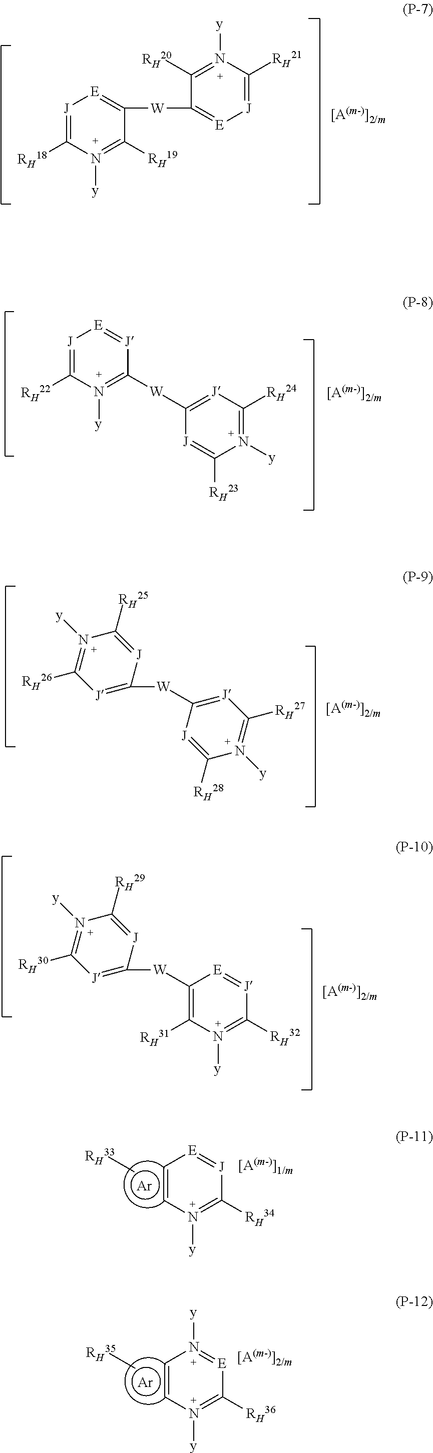
wherein:
each of J and J′, equal to or different from each other, is independently at each occurrence C—R* or N, wherein R* is H or a C₁-C₁₂ hydrocarbon group;
E is N or a group of formula C—R^{o}_{H};
Z is a divalent hydrocarbon group comprising from 1 to 12 carbon atoms;
W is a bond or is a bridging group selected from the group consisting of divalent hydrocarbon groups comprising from 1 to 12 carbon atoms and divalent fluorocarbon groups comprising from 1 to 12 carbon atoms;
the group sketched with symbol: 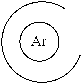
in formula (P-11) and (P-12) designates an aromatic mono- or poly-nuclear ring condensed to the pyridinium-type aromatic ring, which may comprise one or more additional nitrogen atoms, optionally quaternary nitrogen atoms, in the ring(s);
each of R¹_{H}, R²_{H}, R³_{H}, R⁴_{H}, R⁵_{H}, R⁶_{H}, R⁷_{H}, R⁸_{H}, R⁹_{H}, R¹⁰_{H}, R¹¹_{H}, R¹²_{H}, R¹³_{H}, R¹⁴_{H}, R¹⁵_{H}, R¹⁶_{H}, R¹⁷_{H}, R¹⁸_{H}, R¹⁹_{H}, R²⁰_{H}, R²¹_{H}, R²²_{H}, R²³_{H}, R²⁴_{H}, R²⁵_{H}, R²⁶_{H}, R²⁷_{H}, R²⁸_{H}, R²⁹_{H}, R³⁰_{H}, R³¹_{H}, R³²_{H}, R³³_{H}, R³⁴_{H}, R³⁵_{H}, R³⁶_{H} and R^{o}_{H}, equal to or different from each other, is independently at each occurrence-H or a group of formula [group (alpha-H)]: 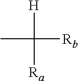
wherein Rₐ, and R_{b}, equal to or different from each other, are independently H or a hydrocarbon C₁-C₆ group;
Y, equal to or different from each other, is independently oxygen or a C₁-C₁₂ hydrocarbon group, which can be notably an aliphatic or an aromatic group, which can comprise one or more than one heteroatoms selected from N, O, S and halogens;
A^{(m-)} is an anion having valency m;
with the proviso that
(i) when salt (P) is of formula (P-1) at least two of R¹_{H}, R²_{H}, and R^{o}_{H} are groups (alpha-H);
(ii) when salt (P) is of formula (P-2) R³_{H} and R⁴_{H} are groups (alpha-H);
(iii) when salt (P) is of formula (P-3), at least two of R⁵_{H}, R⁶_{H}, R⁷_{H}, and R⁸_{H} are groups (alpha-H);
(iv) when salt (P) is of formula (P-4), at least two of R⁹_{H}, R¹⁰_{H}, R¹¹_{H}, R¹²_{H}, and R^{o}_{H} are groups (alpha-H);
(v) when salt (P) is of formula (P-5), at least two of R¹³_{H}, R¹⁴_{H}, and R^{o}_{H} are groups (alpha-H);
(vi) when salt (P) is of formula (P-6), at least two of R¹⁵_{H}, R¹⁶_{H}, R¹⁷_{H}, and R^{o}_{H} are groups (alpha-H);
(vii) when salt (P) is of formula (P-7), at least two of R¹⁸_{H}, R¹⁹_{H}, R²⁰_{H}, R²¹_{H}, and R^{o}_{H} are groups (alpha-H);
(viii) when salt (P) is of formula (P-8), at least two of R²²_{H}, R²³_{H}, R²⁴_{H}, and R^{o}_{H} are groups (alpha-H);
(ix) when salt (P) is of formula (P-9), at least two of R²⁵_{H}, R²⁶_{H}, R²⁷_{H}, and R²⁸_{H} are groups (alpha-H);
(x) when salt (P) is of formula (P-10), at least two of R²⁹_{H}, R³⁰_{H}, R³¹_{H}, R³²_{H}, and R²⁸_{H} are groups (alpha-H);
(xi) when salt (P) is of formula (P-11), at least two of R³³_{H}, R³⁴_{H}, and R²⁸_{H} are groups (alpha-H);
(xii) when salt (P) is of formula (P-12), at least two of R³⁵_{H}, R³⁶_{H} and R^{o}_{H} are groups (alpha-H).

13. The seal according to claim 12, wherein the at least one basic compound [base (B)] in composition (C) is selected from non-aromatic amines of formula R_{bm}—NR^{H}₂
wherein each of R^{H} is independently a C₁-C₁₂ hydrocarbon group;
R_{bm} is a monovalent hydrocarbon non-aromatic group having 1 to 30 carbon atoms.

14. A fuel cell assembly comprising the seal of claim 12 disposed between fuel cell components.

15. A fuel cell stack comprising a plurality of said fuel cell assemblies of claim 14.

16. An aqueous crosslinkable composition [composition (C1)] obtained by mixing:
an aqueous latex comprising particles of at least one vinylidene-fluoride (VDF) based fluoropolymer comprising recurring units derived from vinylidene fluoride (VDF) and optionally from at least one additional comonomer different from VDF [polymer (A)];
at least one is a non-aromatic amine [base (B1)] of formula R_{bm}—NR^{H}₂
wherein each of R^{H} is independently a C₁-C₁₂ hydrocarbon group;
at least one pyridinium salt [salt (P)] complying with any of formulae (P-1) to (P-12)

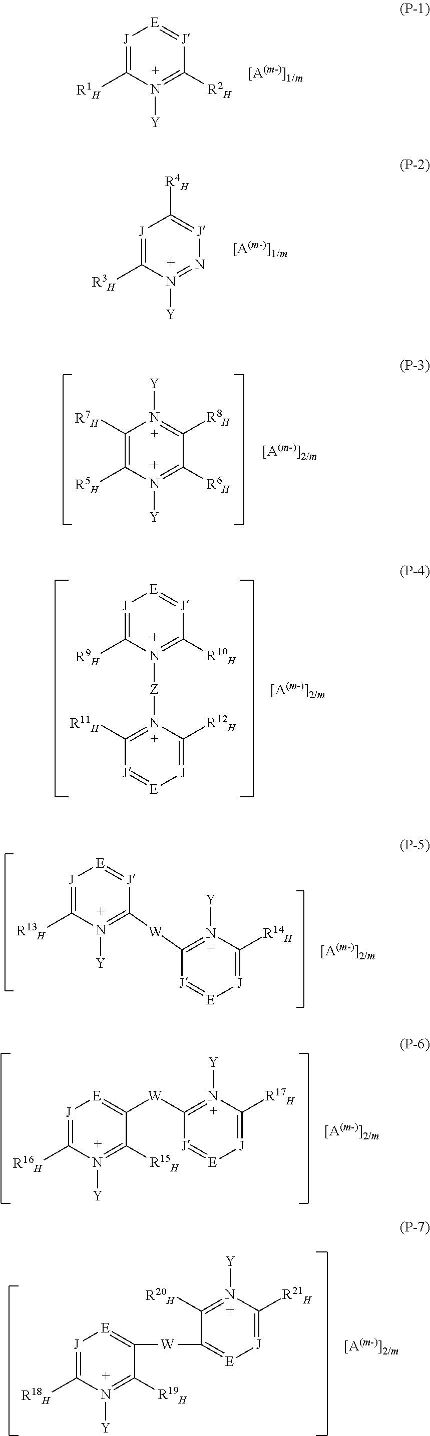

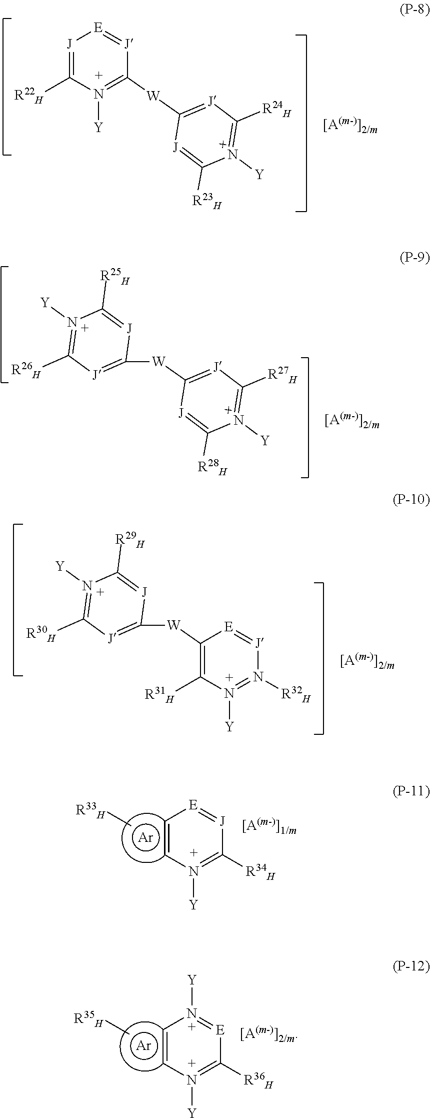

17. The method according to claim 1, wherein W is a bond or is a bridging group selected from the group consisting of divalent aliphatic groups comprising from 1 to 6 carbon atoms and perfluoroaliphatic groups comprising from 1 to 6 carbon atoms.

18. The method according to claim 1, wherein polymer (A) comprises:
recurring units derived from vinylidene fluoride (VDF) in an amount ranging from 65 to 100% moles,
and optionally, recurring units derived from at least one additional comonomer [comonomer (C)] different from VDF, in an amount ranging from 0 to 35% moles.

19. The method according to claim 1, wherein polymer (A) comprises:
recurring units derived from vinylidene fluoride (VDF) in an amount ranging from 75 to 100% moles,
and optionally, recurring units derived from at least one additional comonomer [comonomer (C)] different from VDF, in an amount ranging from 0 to 25% moles.

20. The method of claim 4, wherein ROH is OH.
